(19) United States
(12) Patent Application Publication
(10) Pub. No.: US 2018/0249119 A1
(43) Pub. Date: Aug. 30, 2018

(54) INCREASING EFFECTIVE UPDATE RATE FOR DEVICE DISPLAYS USED IN AUGMENTED REALITY HEAD MOUNT DEVICES

(71) Applicant: Microsoft Technology Licensing, LLC, Redmond, WA (US)

(72) Inventor: Brian K. Guenter, Redmond, WA (US)

(73) Assignee: Microsoft Technology Licensing, LLC, Redmond, WA (US)

(21) Appl. No.: 15/445,725

(22) Filed: Feb. 28, 2017

(51) Int. Cl. H04N 7/01; G06T 11/60; G06F 3/00

(52) U.S. Cl. CPC H04N 7/0127; G06F 3/002; G06T 11/60

(57) ABSTRACT

Displaying a left side image and a right side image on a single display is provided for increasing effective update rate for device displays used in head mount devices. A left side of display image is composited, and the left side of display image is displayed. At a first delayed time interval from the time of compositing the left side of display image, the right side of display image is composited, and at a second delayed time interval from the time of compositing the left side of display image, the right side of display image is displayed.

### BACKGROUND

Augmented reality is becoming a greater part of the computer user experience. Through augmented reality, a computer user wears a head mounted display (“HIVID”) that projects computer generated images onto a real-world scene, thus augmenting the scene with computer generated information. This information can be in the form of graphics or text. Cameras mounted on the head mounted display pick up the images of what the user is looking at in the real world. The display in an HMD may be permanently fixed in the HIVID or may be a device, such as a smartphone or tablet, inserted into the HIVID and used as a display. The cameras mounted on the display capture a stereo view of the real world that is then composited with synthetic imagery.

However, the design goals for devices, such as smartphone displays, and the displays used in augmented reality (AR) head mount devices conflict in several important ways. To minimize power consumption, devices, such as smartphone displays, use relatively low refresh rates, typically 60 Hz. This frequency is too low for virtual reality or augmented reality applications. Current HMD's refresh at 90 Hz, where earlier versions were refreshed at 72 Hz which has been found to cause simulator sickness in a large proportion of the user population.

### SUMMARY

This summary is provided to introduce a selection of concepts in a simplified form that are further described below in the Detailed Description section. This summary is not intended to identify key features or essential features of the claimed subject matter, nor is it intended as an aid in determining the scope of the claimed subject matter.

Aspects are directed to a method of displaying a left side image and a right side image on a single display. The method includes compositing the left side of a display image and displaying the left side of the display image. At a first delayed time interval from the time of compositing the left side of the display image, the right side of the display image is composited, and at a second delayed time interval from the time of compositing the left side of display image, the right side of display image is displayed.

Additional aspects include a head mounted display including a left camera and a right camera, a display having a left side and a right side, and a processor coupled to the left camera, the right camera and the display. The processor is operable to composite a left side scene for display on the left side of the display, to display the left side scene on the left side of the display and to composite a right side scene for display on the right side of the display. The compositing occurs after compositing of the left side scene and after compositing the right side scene and after the right side scene is displayed on the right side of the display.

Additional aspects include a computer storage medium storing computer executable instructions which, when executed by a computer, perform a method comprising the acts of capturing a first side picture from a first camera; compositing the first side picture from the first camera with a first side computer generated image to create a first side scene, and displaying the first side scene on a first side of a display. The method further comprises the acts of capturing a second side picture from a second camera at a first time delayed from the capture of the first side picture, compositing the second side picture from the second camera with a second side computer generated image to create a second side scene, and displaying the second side scene on a second side of the display at a second time delayed from the display of the first side scene.

Examples are implemented as a method, computer process, a computing system, or as an article of manufacture such as a device, computer program product, or computer readable media. According to an aspect, the computer program product is a computer storage media readable by a computer system and encoding a computer program of instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 is a block diagram of an example head mounted display;

FIG. 2 is an illustration of a display within a head mounted display begin refreshed at time t=0 milliseconds (ms);

FIG. 3 is an illustration of a display within a head mounted display begin refreshed at time t=1/(2*refresh rate) ms;

FIG. 4 is a flow chart showing general stages involved in an example method of staggering the left side and the right side of a single display to generate a higher apparent refresh rate;

FIG. 5 is a block diagram illustrating example physical components of a computing device; and

FIGS. 6A and 6B are simplified block diagrams of a mobile computing device.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

This disclosure addresses the problem of creating the perception of a high refresh rate on a low refresh rate device. For example, the disclosure can create the perception of a 120 Hz refresh rate display and camera system using only a 60 Hz display. The perceived refresh rate can be increased by offsetting the refresh of the left and right image by ½ frame time. Some displays, such as smartphone and tablet displays, refresh scan lines sequentially from the top to the bottom of the display. In the case of a display with a 60 Hz refresh rate, when the display is rotated 90 degrees to landscape mode for use in a video augmented reality or virtual reality headset, the display refreshes vertical scan lines from left to right in 1/60th of a second. The left eye image begins 1/120th of a second before the first scanline of the right eye image. Both left and right cameras may be oriented so their output is aligned with the smart phone display, vertical scanlines read from left to right.

The left camera is synchronized to the display to read out its captured image in the first 1/120th second and the right camera is similarly synchronized to be 1/120th of a second later. The staggered camera capture times and synchronization to the display gives the effect of a 120 Hz perceived refresh rate when the left and right eye signals are integrated in the brain. This perceived refresh rate is high enough to eliminate simulator sickness for most people but does not require the smartphone display to refresh at a higher rate than it normally would for conventional cell phone use. This reduces power consumption and cost of display refresh electronics.

While the discussion above has been with respect to smartphone displays used in an HMD, a permanently fixed display in an HMD would also benefit and could be used with this disclosure. In addition, though much of this discussion is with respect to a display with a 60 Hz refresh rate and creating a 120 Hz perceived refresh rate, other refresh rates and perceived rates could also be used.

Furthermore, the processing of the images, capturing of the camera images, compositing of the images, and driving the display can be performed in either a computer attached to the HIVID, within the processor of the HIVID, or using the processor of an inserted smartphone or tablet.

In addition, while the disclosure discusses the staggered display system with respect to a left side of display and a right side of display, if the device, such as a smartphone or tablet, is inserted upside-down, the disclosure could also apply to the use of a right side of display and a left side of display with everything described with respect to left side and right side simply being reversed.

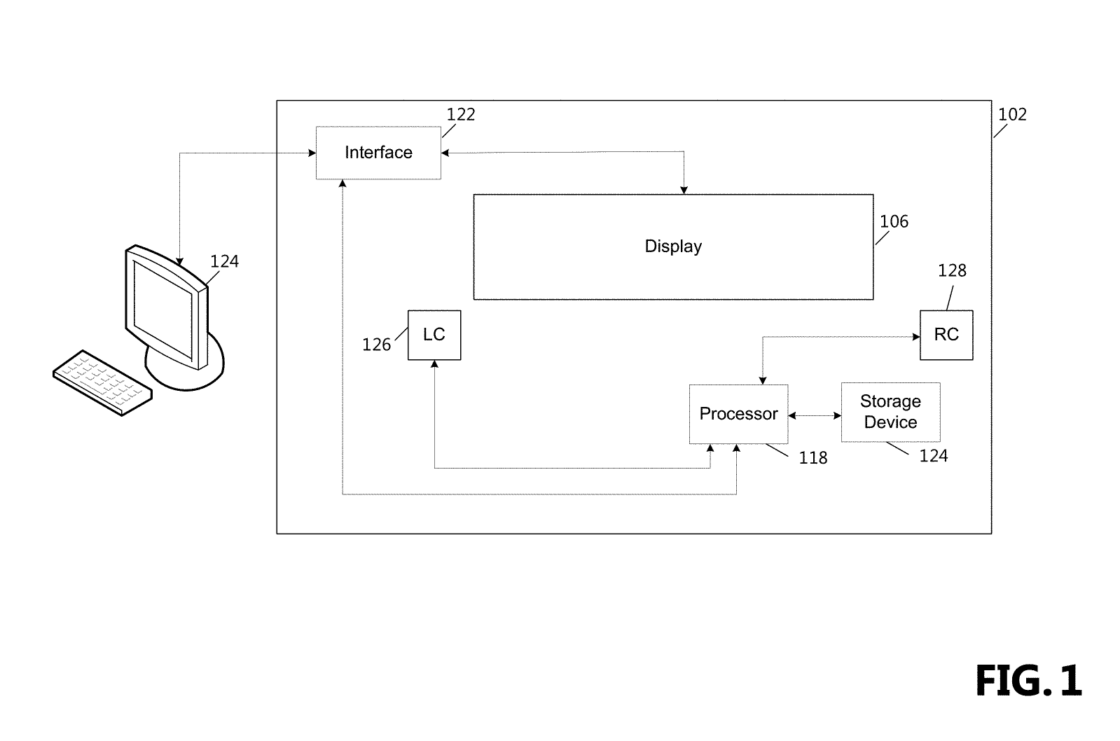

FIG. 1 is a block diagram of an example head mounted display. A head mounted display 102 includes a single display 106. The display 106 may be a built-in display or may be a display found in a removable device, such as a mobile phone, computer, or tablet. The display is coupled via an interface 122 to a processor 118 that handles the control of the camera and the compositing of the binned image with the region of interest. A pair of cameras, left camera 126 and right camera 128, picks up an external scene and is coupled to processor 118. The cameras may be high resolution cameras, typically between 16 megapixels and 50 megapixels. The processor 118 can be, for example, a microprocessor, microcomputer, a digital signal processor, or a graphics processing unit. The processor 118 drives the synchronization signals to the display 106 as well as any synchronization signals to the cameras 126 and 128.

A storage device 124 coupled to the processor 118 stores the images captured by the cameras 126 and 128.

The interface 122 couples the processor 118 to a computer 124. The computer 124 typically provides augmented images and text to be superimposed upon images received from the cameras 126 and 128. While the compositing has been described as being performed by the processor 118, processing of compositing the images may be performed by the computer 124 in alternative embodiments of the disclosure or may be performed by the mobile device that provides the display 106 when the display 106 is a temporary display provided by the mobile device to the HMD 102.

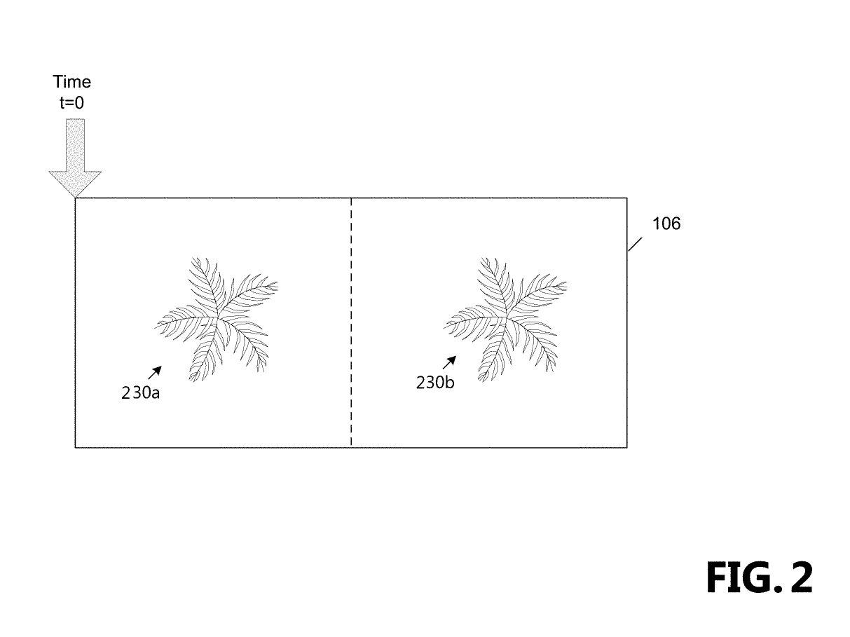

FIG. 2 is an illustration of a display within a head mounted display begin refreshed at time t=0 ms. The display 106 has two halves, a left side and a right side, even though it comprises a single display. The display staggering system described herein drives the display 106 as a single display, but logically may treat the left side of the display 106 and the right side of the display 106 as two separate displays. According to an aspect, the image composited and displayed on the left side of the display 106 is first created at a time t=0, whereas the image composited and displayed on the right side of display 106 is composited and display at a delayed time of t=1/(2*refresh rate) ms. So, for a 60 Hz refresh rate for display 106, the display on the right side is composited and displayed at a time of t=1/(2*60 Hz) or t=8.333 ms.

At time t=0, the left side of display 106 displays an image 230a that was composited and displayed in the previous display refresh and the right side of display 106 displays an image 230b that was composited and displayed in the previous display refresh. According to an aspect, the image 230b was composited and displayed 8.333 ms after the image 230a was composited and displayed. At time t=0, the scan line of display 106 is on the far left side of the display, and the staggered display system composites and prepares to display a new, updated image over image 230a.

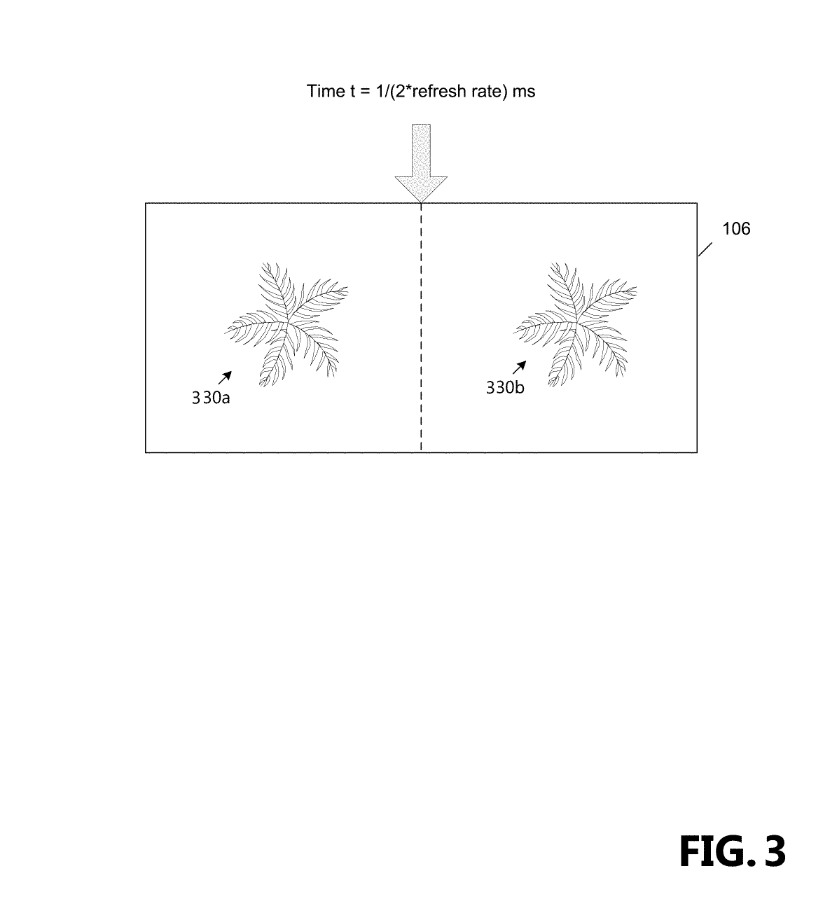

FIG. 3 is an illustration of a display within a head mounted display refreshed at time t=1/(2*refresh rate) ms. According to an example, illustrated in FIG. 3, at this moment in time, image 330a has recently been composited and displayed from time t=0 to time t=1/(2*refresh rate) ms. At this instance shown in the figure, the scan line is about to output the first line of the right side of display 106. At this point, the image 330b is the previous image from the last refresh of display 106. In this instance, or shortly before this instance, a new image for the right side of display 106 is composited and prepared for display. During the time between time t=1/(2*refresh rate) ms and time t=1/refresh rate ms the right side of display 106 will be updated.

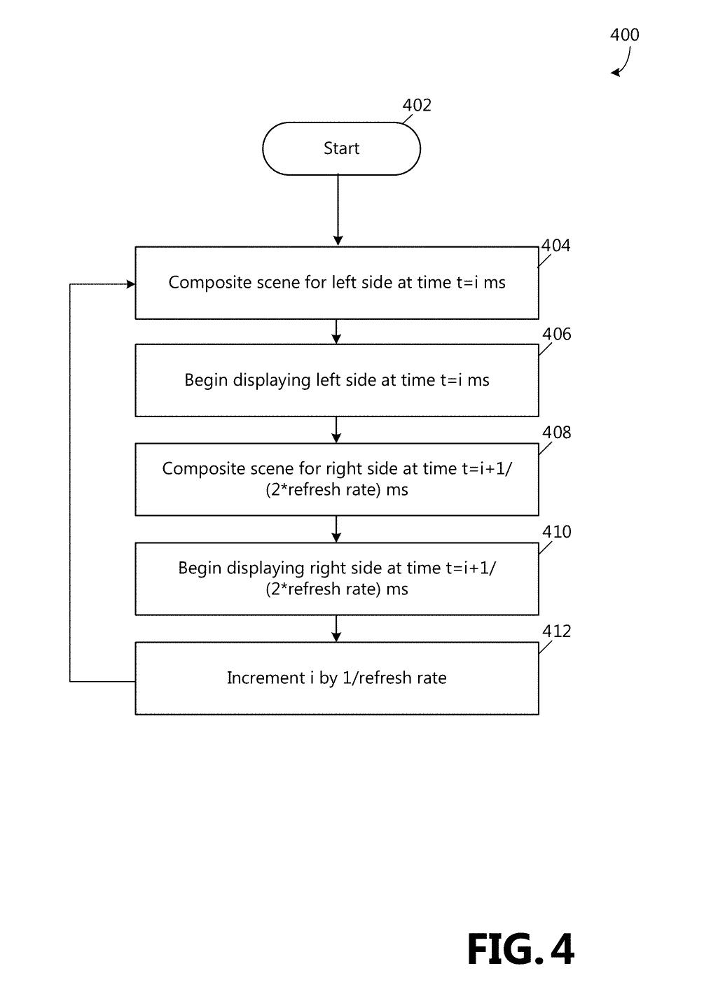

FIG. 4 is a flow chart showing general stages involved in an example method 400 of staggering the left side and the right side of a single display to generate a higher apparent refresh rate. A single physical display is broken up into a logical left side and a logical right side. Starting at OPERATION 400 and continuing to OPERATION 404, the method 400 composites the scene for the left side of the single display at a time t=i ms or shortly before. Initially i=0. In a virtual reality display system, the scene may be composited based on information generated by a computer, the processor in an HMD, or by the single display when the single display is a mobile device, such as a smartphone or tablet. In an augmented reality display system, the scene may be composited based on information from a left side camera in conjunction with information generated by a computer, the processor in an HIVID, or by the single display when the single display is a smartphone or tablet.

The method 400 continues at OPERATION 406 where the left side image begins to be displayed on the single display starting at time t=i. display of the left side image continues through time t=i+1/(2*refresh rate), at which point display of the left side image is completed. At OPERATION 408, the right side image is composited at time t=i+1/(2*refresh rate) or slightly before. In a virtual reality display system, the scene may be composited based on information generated by a computer, the processor in an HIVID, or by the single display when the single display is a smartphone or tablet. In an augmented reality display system, the scene may be composited based on information from a left side camera in conjunction with information generated by a computer, the processor in an HIVID, or by the single display when the single display is a smartphone or tablet.

At OPERATION 410 the right side image begins to be displayed on the single display at time t=i+1/(2*refresh rate) and continues to time t=i+1/(refresh rate). At this point in time, both the left side and the right side of the single display have been refreshed. At OPERATION 412 i is incremented by 1/refresh rate, and flow continues at OPERATION 404. Thus, the left side and right side of the single display are refreshed at staggered intervals to give the perception of twice the standard refresh rate.

The aspects and functionalities described herein may operate via a multitude of computing systems including, without limitation, head mounted displays with and without computer assistance, or head mounted displays in conjunction with desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein may operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected.

Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

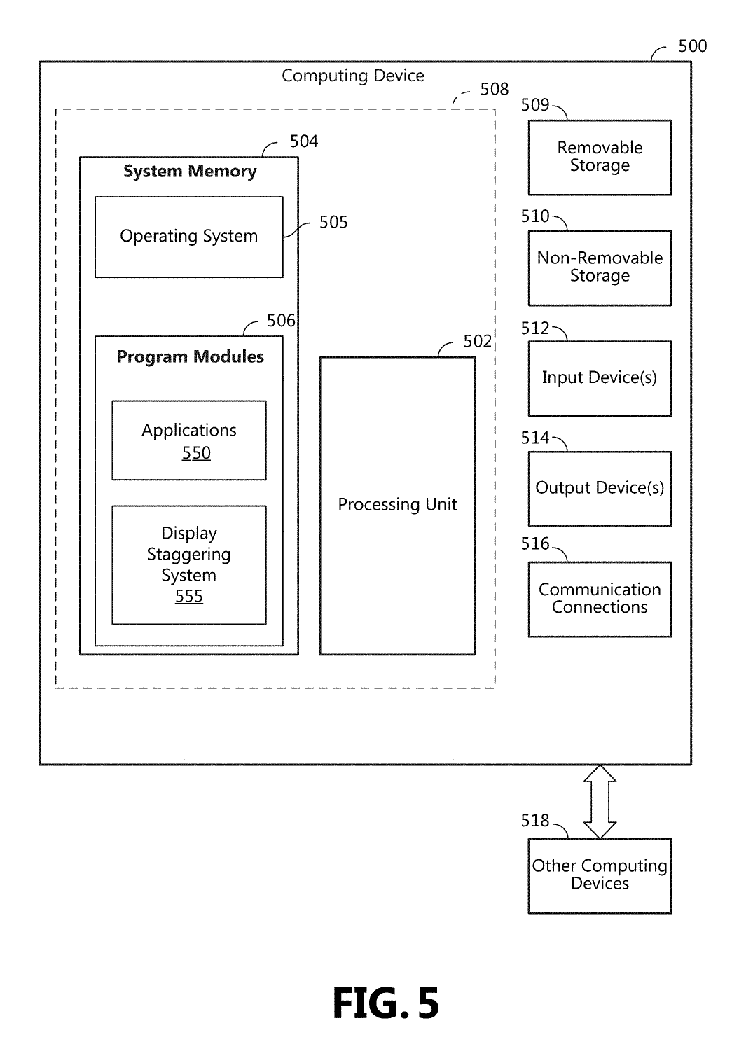

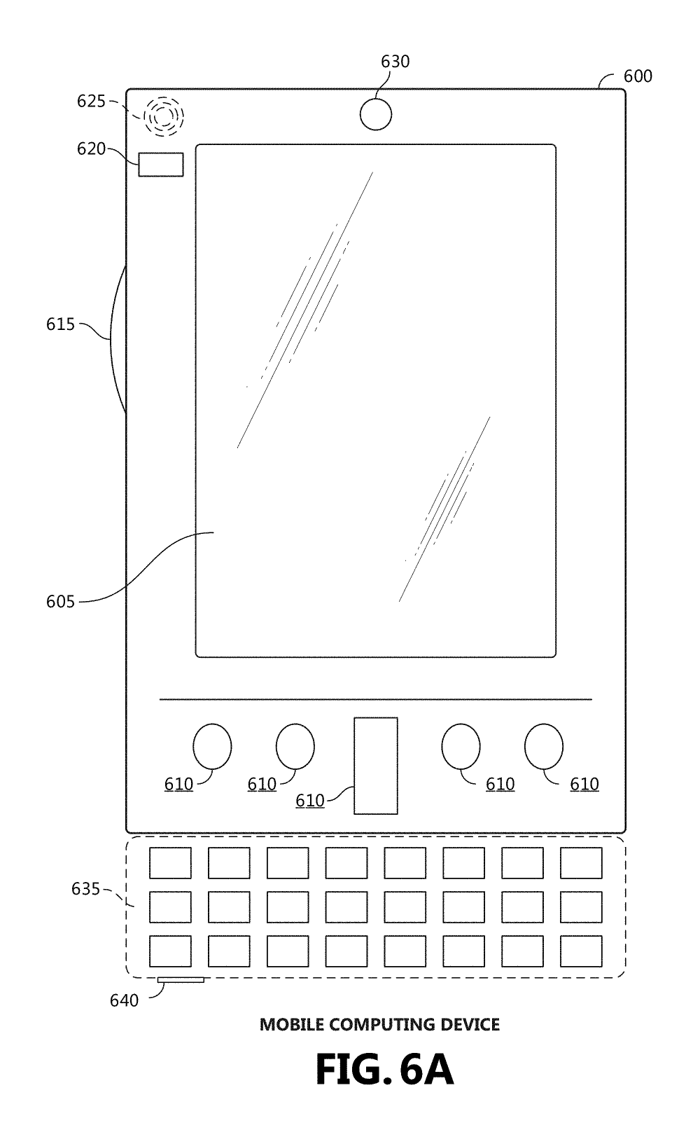

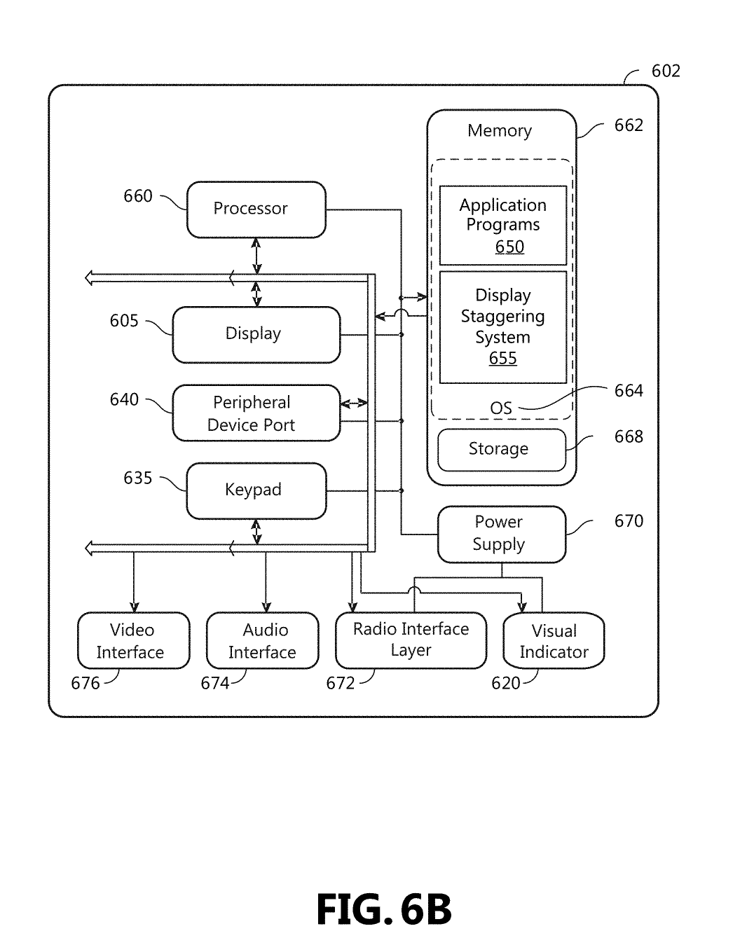

FIGS. 5-6B and the associated descriptions provide a discussion of a variety of operating environments in which examples are practiced. However, the devices and systems illustrated and discussed with respect to FIGS. 5 and 6 are for purposes of example and illustration and are not limiting of a vast number of computing device configurations that are utilized for practicing aspects, described herein.

FIG. 5 is a block diagram illustrating physical components (i.e., hardware) of a computing device 500 with which examples of the present disclosure may be practiced. In a basic configuration, the computing device 500 includes at least one processing unit 502 and a system memory 504. According to an aspect, depending on the configuration and type of computing device, the system memory 504 comprises, but is not limited to, volatile storage (e.g., random access memory), non-volatile storage (e.g., read-only memory), flash memory, or any combination of such memories. According to an aspect, the system memory 504 includes an operating system 505 and one or more program modules 506 suitable for running software applications 550. According to an aspect, the system memory 504 includes the display staggering system 555. The operating system 505, for example, is suitable for controlling the operation of the computing device 500. Furthermore, aspects are practiced in conjunction with a graphics library, other operating systems, or any other application program, and are not limited to any particular application or system. This basic configuration is illustrated in FIG. 5 by those components within a dashed line 508. According to an aspect, the computing device 500 has additional features or functionality. For example, according to an aspect, the computing device 500 includes additional data storage devices (removable and/or non-removable) such as, for example, magnetic disks, optical disks, or tape. Such additional storage is illustrated in FIG. 5 by a removable storage device 509 and a non-removable storage device 510.

As stated above, according to an aspect, a number of program modules and data files are stored in the system memory 504. While executing on the processing unit 502, the program modules 506 (e.g., display staggering system 555) perform processes including, but not limited to, one or more of the stages of the methods 400 illustrated in FIG. 4. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit utilizing a microprocessor, or on a single chip containing electronic elements or microprocessors. For example, aspects are practiced via a system-on-a-chip (SOC) where each or many of the components illustrated in FIG. 5 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 500 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 500 has one or more input device(s) 512 such as a keyboard, a mouse, a pen, a sound input device, a touch input device, etc. The output device(s) 514 such as a head mounted display, speakers, a printer, etc. are also included according to an aspect. The aforementioned devices are examples and others may be used. According to an aspect, the computing device 500 includes one or more communication connections 516 allowing communications with other computing devices 518. Examples of suitable communication connections 516 include, but are not limited to, radio frequency (RF) transmitter, receiver, and/or transceiver circuitry; universal serial bus (USB), parallel, and/or serial ports.

The term computer readable media as used herein include computer storage media. Computer storage media include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (i.e., memory storage.) According to an aspect, computer storage media includes RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. According to an aspect, any such computer storage media is part of the computing device 500. Computer storage media does not include a carrier wave or other propagated data signal.

According to an aspect, communication media is embodied by computer readable instructions, data structures, program modules, or other data in a modulated data signal, such as a carrier wave or other transport mechanism, and includes any information delivery media. According to an aspect, the term “modulated data signal” describes a signal that has one or more characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

FIGS. 6A and 6B illustrate a mobile computing device 600, for example, a mobile telephone, a smart phone, a tablet personal computer, a laptop computer, and the like, with which aspects may be practiced. With reference to FIG. 6A, an example of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. According to an aspect, the display 605 of the mobile computing device 600 functions as an input device (e.g., a touch screen display). If included, an optional side input element 615 allows further user input. According to an aspect, the side input element 615 is a rotary switch, a button, or any other type of manual input element. In alternative examples, mobile computing device 600 incorporates more or less input elements. For example, the display 605 may not be a touch screen in some examples. In alternative examples, the mobile computing device 600 is a portable phone system, such as a cellular phone. According to an aspect, the mobile computing device 600 includes an optional keypad 635. According to an aspect, the optional keypad 635 is a physical keypad. According to another aspect, the optional keypad 635 is a “soft” keypad generated on the touch screen display. In various aspects, the output elements include the display 605 for showing a graphical user interface (GUI), a visual indicator 620 (e.g., a light emitting diode), and/or an audio transducer 625 (e.g., a speaker). In some examples, the mobile computing device 600 incorporates a vibration transducer for providing the user with tactile feedback. In yet another example, the mobile computing device 600 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 600 incorporates peripheral device port 640, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one example of a mobile computing device. That is, the mobile computing device 600 incorporates a system (i.e., an architecture) 602 to implement some examples. In one example, the system 602 is implemented as a “smart phone” capable of running one or more applications (e.g., browser, e-mail, calendaring, contact managers, messaging clients, games, and media clients/players). In some examples, the system 602 is integrated as a computing device, such as an integrated personal digital assistant (PDA) and wireless phone.

According to an aspect, one or more application programs 650 are loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. According to an aspect, the display staggering system 655 is loaded into memory 662. The system 602 also includes a non-volatile storage area 668 within the memory 662. The non-volatile storage area 668 is used to store persistent information that should not be lost if the system 602 is powered down. The application programs 650 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600.

According to an aspect, the system 602 has a power supply 670, which is implemented as one or more batteries. According to an aspect, the power supply 670 further includes an external power source, such as an AC adapter or a powered docking cradle that supplements or recharges the batteries.

According to an aspect, the system 602 includes a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 650 via the operating system 664, and vice versa.

According to an aspect, the visual indicator 620 is used to provide visual notifications and/or an audio interface 674 is used for producing audible notifications via the audio transducer 625. In the illustrated example, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. According to an aspect, the system 602 further includes a video interface 676 that enables an operation of an on-board camera 630 to record still images, video stream, and the like.

According to an aspect, a mobile computing device 600 implementing the system 602 has additional features or functionality. For example, the mobile computing device 600 includes additional data storage devices (removable and/or non-removable) such as, magnetic disks, optical disks, or tape. Such additional storage is illustrated in FIG. 6B by the non-volatile storage area 668.

According to an aspect, data/information generated or captured by the mobile computing device 600 and stored via the system 602 is stored locally on the mobile computing device 600, as described above. According to another aspect, the data is stored on any number of storage media that is accessible by the device via the radio 672 or via a wired connection between the mobile computing device 600 and a separate computing device associated with the mobile computing device 600, for example, a server computer in a distributed computing network, such as the Internet. As should be appreciated such data/information is accessible via the mobile computing device 600 via the radio 672 or via a distributed computing network. Similarly, according to an aspect, such data/information is readily transferred between computing devices for storage and use according to well-known data/information transfer and storage means, including electronic mail and collaborative data/information sharing systems.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

I claim:

1. A method of displaying a left side image and a right side image on a single display, comprising:
compositing the left side of a display image;
displaying the left side of the display image;
at a first delayed time interval from the time of compositing the left side of display image, compositing the right side of the display image; and
at a second delayed time interval from the time of compositing the left side of display image, displaying the right side of the display image.

2. The method of claim 1, wherein the first delayed time and the second delayed time are about the same time.

3. The method of claim 1, wherein the first delayed time is smaller than the second delayed time.

4. The method of claim 1, wherein compositing the left side of the display image comprises compositing a computer generated image with an image generated by a left side camera.

5. The method of claim 1, wherein compositing the left side of the display image comprises compositing a computer generated image.

6. The method of claim 1, wherein the first delayed time interval is about 1/120^{th} of a second.

7. The method of claim 1, wherein the second delayed time interval is about 1/120^{th} of a second.

8. A head mounted display, comprising:
a left camera and a right camera;
a display having a left side and a right side; and
a processor coupled to the left camera, the right camera and the display, the processor operable to:
composite a left side scene for display on the left side of the display;
display the left side scene on the left side of the display;
composite a right side scene for display on the right side of the display, the compositing occurring after compositing of the left side scene; and
after compositing the right side scene, displaying the right side scene on the right side of the display.

9. The head mounted display of claim 8, wherein compositing the left side scene comprises compositing the left side scene from a combination of computer generated graphics and a left image from the left camera.

10. The head mounted display of claim 8, wherein compositing the right side scene occurs about 8.3 milliseconds (ms) after compositing the left side scene.

11. The head mounted display of claim 8, wherein the display has a refresh rate and the compositing of the right side scene occurs about 1/(2*refresh rate) ms after compositing the left side scene.

12. The head mounted display of claim 9, wherein compositing the right side scene comprises compositing the right side scene from a combination of computer generated graphics and a right image from the right camera.

13. The head mounted display of claim 12, wherein the right image is captured about 1/(2*refresh rate) ms after capturing the left image.

14. A computer storage medium storing computer executable instructions which, when executed by a computer, perform a method comprising the acts of:
capturing a first side picture from a first camera;
compositing the first side picture from the first camera with a first side computer generated image to create a first side scene;
displaying the first side scene on a first side of a display;
capturing a second side picture from a second camera at a first time delayed from the capture of the first side picture;
compositing the second side picture from the second camera with a second side computer generated image to create a second side scene; and
displaying the second side scene on a second side of the display at a second time delayed from the display of the first side scene.

15. The computer storage medium of claim 14, wherein the first side is the left side and the second side is the right side.

16. The computer storage medium of claim 14, wherein the first time delayed and the second time delayed are about the same time.

17. The computer storage medium of claim 14, wherein the first time delayed is shorter than the second time delayed.

18. The computer storage medium of claim 14, wherein the first time delayed is about 1/(2*refresh rate), where refresh rate is the refresh rate of the display.

19. The computer storage medium of claim 14, wherein the first time delayed is about 8.3 ms.

20. The computer storage medium of claim 14, further comprising instructions to repeat the acts claimed about every 16.7 ms.
